(19) United States
(12) Patent Application Publication
(10) Pub. No.: US 2024/0382826 A1
(43) Pub. Date: Nov. 21, 2024

(54) ELECTROMAGNETIC LAUNCHER FOR ROULETTE GAMING SYSTEMS

(71) Applicant: Interblock d.o.o., Las Vegas, NV (US)

(72) Inventor: Urban BERGANT, Kamnik (SI)

(21) Appl. No.: 18/317,601

(22) Filed: May 15, 2023

(51) Int. Cl. A63F 5/00

(52) U.S. Cl. CPC A63F 5/0005; A63F 5/0082

(57) ABSTRACT

A ball launch system and roulette gaming methods are disclosed herein. A launch system may include an electromagnetic coil including a plurality of windings around a ball path, a magnetic piston configured to travel along the ball path, and a control system. The control system may receive a launch signal from a roulette gaming device and sequentially activate a first winding and a second winding of the electromagnetic coil to accelerate the magnetic piston from a start position. The magnetic piston may launch a roulette ball positioned within the ball path through an exit point of the ball path at a timing and a speed associated with the launch signal.

### TECHNICAL FIELD

The present disclosure relates to roulette gaming apparatus and more particularly to roulette ball launch apparatus or systems and methods for using the same.

### BACKGROUND

Roulette is a popular game played in gaming establishments. In mechanical versions of the game (versus video generated), a roulette ball is launched into a stationary rim having a single angled annular track encircling a spinning roulette wheel. The spinning wheel rotates in the opposite direction of the rotating roulette ball. The roulette ball rotates around the annular track until friction between the roulette ball and the annular track and gravity cause the ball to lose momentum. Upon losing sufficient momentum, the roulette ball exits the annular track and falls on to the roulette wheel.

Between the track and the roulette wheel, the roulette ball may engage with one or more ball stops (or canoes) intervening between the annular track and the roulette wheel, causing the ball to randomly jump about. Eventually the roulette ball will come to rest in one of the numerous equally spaced ball slots located along a circumference of the roulette wheel. Each ball slot among the equally spaced ball slots is isolated from adjacent ball slots by separators positioned radially outward and corresponds to a particular number, symbol and/or color. The particular number, symbol and/or color represents a result for the game cycle that began when the roulette ball was launched.

As the roulette ball comes to rest, a marker (or dolly) may be used to mark a betting area (or layout) of a display or a physical horizontal surface that is separate from the roulette mechanism. The dolly identifies the particular number, symbol and/or color on the layout corresponding to the ball slot in which the roulette ball came to rest. Winning and losing selections for that game cycle that had been electronically or physically placed on the selection area prior to a selection close time of that game cycle are then determined according to the result. Once the losing and winning selections are resolved, a new game cycle starts.

Although roulette can be a fun and exciting on its own, there have been numerous attempts to add further fun and excitement by modifying aspects of roulette as structured in different parts of the world. Roulette systems may include a number of numbers on the number circle spaced apart and arranged in different manners. The number circles of roulette wheels typically include at least 36 numbers. Some number circles may include additional numbers and symbols and the roulette wheels may include a corresponding number of ball slots, which can change the arrangement of the numbers and symbols of the number circle. Number circles including an extra number are typically numbered “0”, two extra numbers are typically numbered “0” and “00”, etc. The zeros numbers are typically green and therefore neither even nor odd. FIG. 1 is an exemplary illustration of a prior art roulette wheel system 10, including a roulette wheel 12 that spins in one direction and is surrounded by a stationary annular track 14 within which a ball 16 is spun in the opposite direction of the roulette wheel's spin. A surface of the roulette wheel 12 slopes toward that ball slots 18, which are surrounded by the number circle 19. The number circle 19 illustrated in FIG. 1 corresponds to a 37 number roulette system with one added “0” but other numbers, more or fewer “0's”, symbols, etc., may be used.

Interactive modifications are another approach to add excitement and variety to the player experience. Interactive features may enable players to customize gameplay through control of one or more game variables. However, this may create additional challenges since player interactions may affect gameplay and the randomness of outcomes, which may be necessary for fairness considerations, gaming regulations, and profitability, among other things. Interactive modifications may also become outdated or unappealing after a period of time due to customer familiarity.

Any physical components and/or devices providing interactive features must also be maintained to keep the gaming device functional and online. Offline time related to repairs of interactive features may result in lower profitability and a decreased player experience, since less roulette gaming devices are available for play.

### SUMMARY

A roulette ball launch system and method of using are disclosed. A ball launch system may include an electromagnetic coil comprising a plurality of windings around a ball path, a magnetic piston configured to travel along the ball path, and a control system. The control system may be configured to receive a launch signal from a roulette gaming device and sequentially activate a first winding and a second winding of the electromagnetic coil to accelerate the magnetic piston from a start position. The accelerated magnetic piston launches a roulette ball positioned within the ball path through an exit point of the ball path at a timing and a speed associated with the launch signal.

Various roulette ball launching methods may include receiving a roulette ball at a start position, applying a first current to first winding of an electromagnetic coil to drive a magnetic piston at the start position along a ball path defined by the electromagnetic coil, applying a second current to a second winding of the electromagnetic coil to adjust a speed of the magnetic piston, driving, by the magnetic piston, a roulette ball through an exit point of the ball path at a timing and a speed associated with the launch command, and returning the magnetic piston to the start position.

Roulette gaming systems, methods, and devices, may receive a launch command from a player-activated launch controller, generate a ball launch sequence based on the launch command, and launch the roulette ball according to the ball launch sequence. The launch command may be indicative of a speed and a timing for launching a roulette ball from a start position into a rotating roulette wheel. The ball launch sequence may include applying a first current to a first winding of an electromagnetic coil to drive a magnetic piston from a start position along a ball path defined by the electromagnetic coil and applying a second current to a second winding of the electromagnetic coil to adjust a speed of the magnetic piston.

### BRIEF DESCRIPTION OF THE DRAWINGS

FIG. 1 is an illustration of a prior art roulette wheel.

FIG. 2 is a cross-sectional view of the ball launching device in accordance with an embodiment.

FIG. 3A is a front perspective view of a ball launching device in accordance with an embodiment.

FIG. 3B is a rear perspective view of a ball launching device in accordance with an embodiment.

FIG. 4 is a perspective view of a roulette wheel with a mounted ball launching device in accordance with an embodiment.

FIG. 5 is a side view of a roulette wheel with a mounted ball launching device in accordance with an embodiment.

FIG. 6 is side view of a roulette wheel with a mounted ball launching device in accordance with an embodiment.

FIG. 7 is a bottom perspective view of a roulette wheel with a mounted ball launching device in accordance with an embodiment.

FIG. 8 is a block diagram of an embodiment of a computer system.

### DETAILED DESCRIPTION OF ILLUSTRATIVE EMBODIMENTS

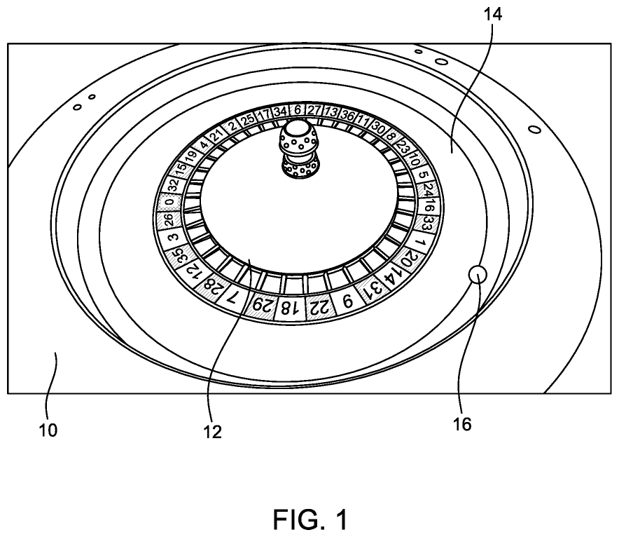

Most roulette mechanisms have a stationary rim, base, and cone and a rotating roulette wheel positioned in the middle of the base. The roulette wheel includes a number of pockets configured to hold the roulette ball. A number between 0 and 36 (and also 00 on some roulette wheels), a symbol and/or a color (typically green for 0 and 00, perhaps other colors for symbols, and alternating between red and black for the other numbers) are assigned to each of the pockets. The stationary rim includes one or more angled annular tracks in which one or more roulette balls manually spin. At the beginning of a game cycle, typically after further selections are closed, a dealer will either manually spin a single roulette ball in the track or the roulette balls will be launched from a launch tube. The roulette balls spin in the opposite direction of the rotating roulette wheel. When a roulette ball eventually exits the track, the ball will ultimately land in one of the pockets, which may indicate the end of a game cycle. FIG. 1 is an illustration of a prior art roulette system with 37 pockets 18 and the numbers 0-36 on the number circle 19.

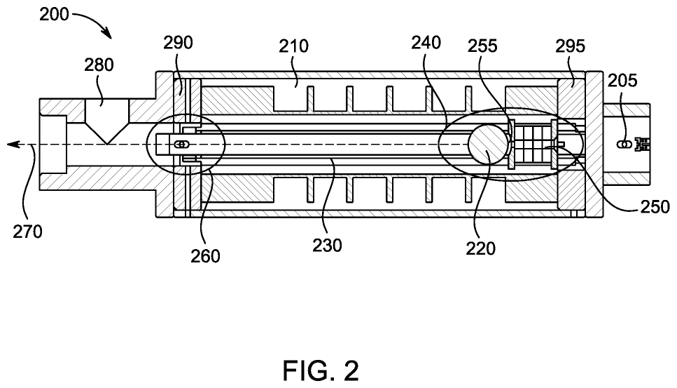

FIG. 2 illustrates a cross-sectional view of a ball launching system 200. In various embodiments, the ball launching system 200 may utilize an electromagnetic device such as a voice coil motor. The electromagnetic device may include a plurality of coil windings 210, and a movable magnetic component, such as magnetic piston 250. The plurality of coil windings may be connected to a motor configured to provide electric current through respective coils of wire, and thereby generate a magnetic field to adjust the movable magnetic component with high precision. In various embodiments, the coil wire may be made of copper or another conductive material. The coil windings may be connected to a power source such as a battery or a capacitor bank.

The plurality of coil windings 210 may be positioned around a ball path 270. In some embodiments, there are six coil windings, as illustrated in FIG. 2. However, more or less coil windings may be implemented, depending on design considerations. Each coil winding may be separately driven, such that electric current is applied to each winding 210 at a desired time. In some cases, current may be applied to a first winding and a second winding sequentially or simultaneously. Both the timing and the duration of applied current to each coil winding may occur independently. In this manner, the magnetic field generated within each coil winding may move the magnetic piston 250 in a desired direction and speed.

The magnetic piston 250 may be configured to travel along the ball path 270. A set of rods 230 may run along the ball path 270 and serve as guides for the magnetic piston 250. In some embodiments, the set of rods may be metal rods, such as stainless steel, INOX, or another non-oxidizing, durable material. In other examples the set of rods include one, two, three, four or more rods. The magnetic piston 250 may include a magnet and a material, such as a synthetic material 255, to form a sliding bearing. One or both lateral ends may include a material, such as the synthetic material, serving as a cushion or bumper when engaging the roulette ball 220 or the end wall 295 at the start position 240.

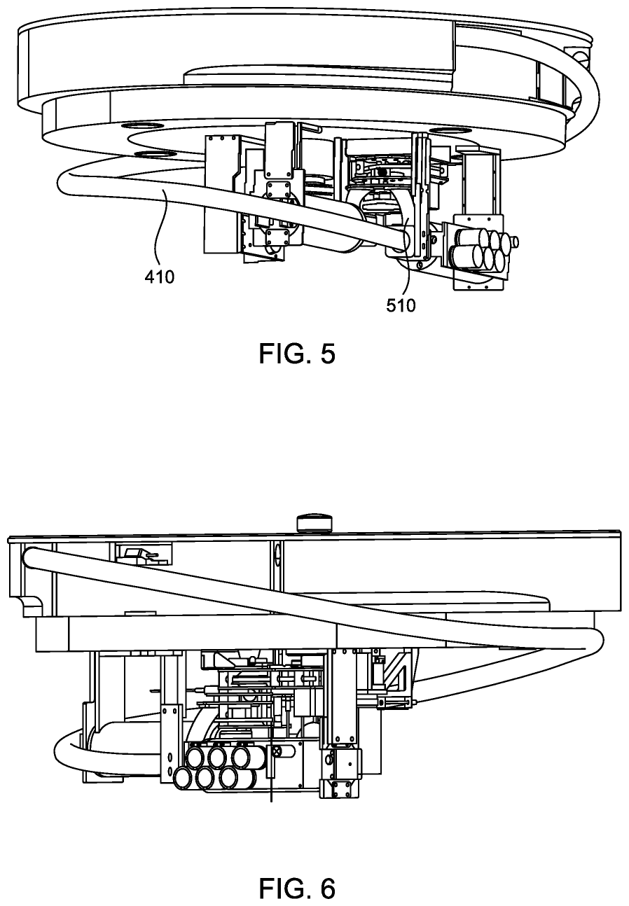

A roulette ball 220 may enter the ball launching system 220 via an inlet 280. FIG. 2 illustrates an example where a roulette ball 220 may enter inlet 280 and travel through the exit point 260, and along the ball path 270 to the start position. In some embodiments, the ball inlet 280 may be positioned elsewhere on the ball launching system 200. As discussed herein, and seen in FIG. 5, the ball launching system 200 may be tilted at an angle. The angled positioning allows the roulette ball 220 to roll, via gravity, to the start position 240 from the inlet 280. The ball inlet 280 may be connected to a tube connected to the roulette wheel. In some examples, a roulette ball 220 may be transferred directly from the roulette wheel to the inlet 280. In other examples, the inlet may be connected to a container storing roulette balls. The exit point 260 may be connected to a launch tube, which guides the roulette ball along the ball path to the roulette wheel, e.g., to initiate a new round of play.

The ball launching system 200 enables high acceleration and high speed, dynamic movements of the magnetic piston to launch the roulette ball from the start position 240 through an exit point 260. Through precise control of current levels applied to two or more of the coil windings, as well as a precise timing of activation, the magnetic piston may be consistently driven, with a desired speed and acceleration, along the ball path 270. This control enables consistent roulette ball launches with a desired speed and timing. A control system 205 may manage communications, signals, and inputs between various components, such as the motor and a roulette gaming system to effectuate the above control operations.

In various examples, the ball launching system 200 may include a plurality of ball launching phases during operation. In a first phase, the magnetic piston 250 and a roulette ball 220 may be in a start position 240, as seen in FIG. 2. A first coil winding, e.g., the coil winding nearest to the start position may be activated. The first coil winding's activation causes the magnetic piston to move forward along the ball path 270. When the magnetic piston 250 reaches a first position, such as the center of the second winding, current to the first coil winding may be stopped, and the second coil winding may be activated. This same process may be continued when the magnetic piston 250 reaches the third coil winding. That is, when the magnetic piston reaches the center of the third coil winding, current to the second coil winding may be stopped, and the third coil winding may be activated.

In some cases, this process can continue for all coil windings within the ball launching system. In other cases, when the magnetic piston reaches or passes a certain point, such as a halfway point of the plurality of coil windings, a braking phase may occur.

In an example, referring to FIG. 2, when the magnetic piston reaches the middle of the plurality of windings, the polarity of the current may be reversed on the next coil winding. That is, when the magnetic piston reaches the fourth coil winding, current to the third coil winding is stopped, and the fourth coil winding is activated with an opposite polarity as the first three coil windings. The opposite polarity causes the magnetic piston to slow or stop, depending on the current level. If the magnetic piston then reaches the fifth winding, the fourth coil winding may be deactivated, and the fifth coil winding may be activated with the same polarity as the fourth coil winding. The same process can occur between the fifth and sixth coil windings.

When the magnetic piston reaches a given position, such as a center point, of a final coil winding (e.g., the sixth coil winding or another coil winding in FIG. 2), the magnetic piston may be stopped. The magnetic piston may stop due to the activation of the final coil to slow movement of the piston, or a mechanical stop when it hits an end wall 290 of the ball path 270.

The magnetic piston's movement will drive the roulette ball forward through the exit point 260. When the magnetic piston starts to slow, e.g., when the forward activation is turned off or reversed, the roulette ball begins traveling freely with the same speed the magnetic piston had at the moment the magnetic piston started to stop. The roulette ball may then travel through the exit point 260 through a tube or other pathway to the roulette wheel.

The magnetic piston may be returned to the start position 240 via activation of the plurality of coil windings 210. In some examples, the magnetic piston may be returned using a reverse process of the launching phases described above. That is, the final coil winding, e.g., the sixth coil winding, may be turned on with the same current and polarity applied to slow or stop the magnetic piston. Similar deactivation and activation actions may sequentially occur for the remaining coil windings until the magnetic piston reaches the start position 240. At any point after roulette ball 220 has exited the ball path 270 via exit point 260, a new roulette ball may be delivered via inlet 280.

The ball launch system 200 may include one or more sensors 205 to detect a position of the magnetic piston and assist/or with any or all of the coil winding activations discussed herein. As shown in FIG. 2, the one or more sensors 205 are shown located behind the end wall 295 relative to the start position 240, but the one or more sensors 205 could be located at other points along the ball path 270. In some examples, the sensor is a magnetic sensor. The magnetic sensor can track or otherwise identify a position of the magnetic piston 250 along a portion of the ball path 270. When the sensor determines that the magnetic piston has reached a particular position, e.g., a center point of a coil winding, the sensor information may cause a controller to start or stop current to a particular coil winding or adjust a polarity of a current winding.

In some cases, the sensor information may be useful for gameplay operations. The sensor information may provide information about a ball launch timing or speed, based on the movement of the magnetic piston. The sensor information may also be usable to indicate when a game has started (e.g., upon a ball launch), when a game is ready to begin (e.g., when the magnetic piston and roulette ball are in the start position 240), or a speed of the ball at launch, among other things. Other sensors usable in various embodiments include, but are not limited to, optic sensors, proximity sensors, force sensors, pressure sensors, material sensors, color sensors, and position sensors.

In various embodiments, the roulette ball launch speed and/or launch time may depend on a gaming event. Any of a variety of gaming events and scenarios may be implemented using the player-activated launch controller. For example, a player-activated launch controller may generate a launch signal causing the coil windings to be activated. The launch signal may be initiated based on a player hitting a button or other selection, which may be physical or virtual. For example, a physical “bash button” may provide launch speed and/or timing information based on a force with which a player has hit the button. The launch controller may initiate a plurality of launch speeds depending on the force from the player. For example, the launch controller may initiate two, three, four, five, six, or more launch speeds. In various gaming scenarios, the time at which the launch controller (e.g., a bash button, physical device, virtual button, screen selection, etc.) is activated may cause the ball launch system 200 to launch a roulette ball substantially simultaneously. In other examples, there may be a delay between player activation and ball launch.

According to some gaming events, the player-activated launch controller may require multiple “hits” or selections to launch a roulette ball. A first selection may cause a roulette ball to be loaded into the launch system, and a second selection may control a timing and/or speed of launch. In other examples, multiple selections may indicate launch instructions for multiple roulette balls. Successive ball launches may occur based on the timing and/or force of each selection. As such, a player may control how fast one or more balls are launched.

Although players may control when and/or how fast a ball is launched, roulette gaming events still remain randomized due to the rotation of the wheel staying constant. In other words, roulette gaming events remain random since the speed of the rotation of the wheel remains independent and will not be based on the speed of roulette ball. In embodiments, the player-activated launch controller may also include a random-event generator that injects some type of randomizing event, such as slightly increasing or decreasing the speed or launch time irrespective of how hard or how quickly a player may have hit a button or otherwise selected the launching of a roulette ball.

According to some roulette gaming examples, the speed of the roulette wheel may be adjusted and/or controlled by the player-activated launch controller or another player-activated device. For example, the roulette wheel speed may be set before or after bets are closed, or both before and after bets are closed. A speed change could be made before or after a ball launch or both. In another example, a first speed change could be made after a player launches a ball, and a second speed change could made after bets close. In these examples, although the player may control one or more speed changes of the roulette wheel, and may control aspects of the ball launch as discussed herein, the roulette gaming event remains randomized.

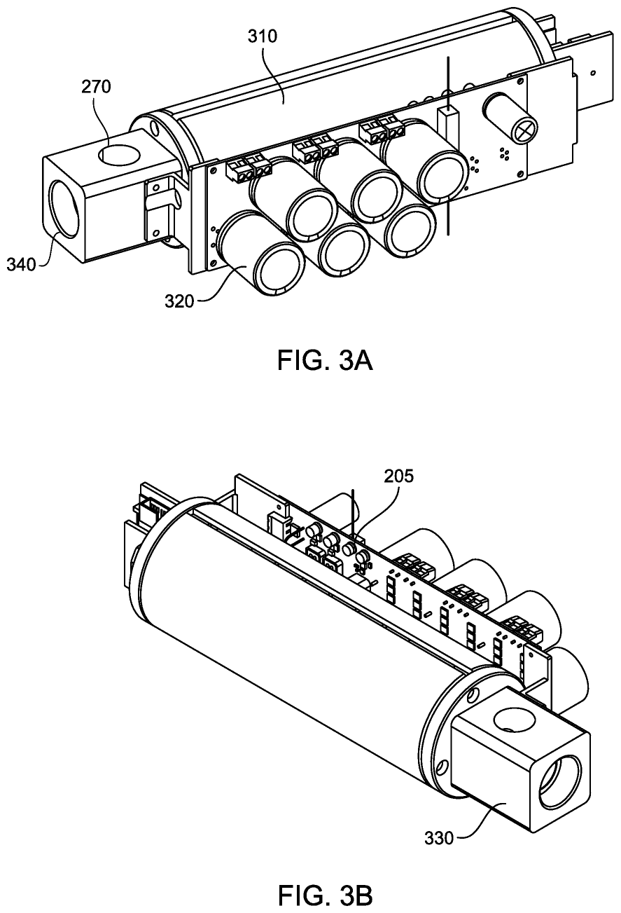

FIGS. 3A and 3B illustrate perspective front and rear views of a ball launching system 200. An outer shell 310 may encase various components illustrated in FIG. 2. The shell 310 may include metal, plastic, or a combination of materials. Control system components may be affixed to the outer shell and connected to the plurality of coil windings 210. FIG. 3A illustrates an external portion 310 of the coil windings 210, mounted to a circuit board of the control system 205. In various examples, the external portion may connect to one or more power sources, or otherwise provide the connectivity and communication to the control system 205, other ball launch components, and/or roulette gaming components.

FIGS. 3A-3B further illustrate a guide component 330 for receiving and ejecting a roulette ball. In some examples, the guide component is formed as part of the ball launching mechanism 220. For example, the guide component may form part of the outer shell 310. In other examples, the guide component may be mounted or otherwise affixed to the outer shell or another attachment point on the ball launching mechanism. The guide component may be permanent or removable. The guide component may include an inlet 270 and exit 340, configured to respectively receive and eject the roulette ball. Either or both of the inlet 270 and exit 340 may be attached to a tube, such as a return tube that delivers the ball from the roulette wheel, a roulette pocket, or a storage container to the inlet 270, or a launch tube which connects the exit 240 to a launch point on the roulette wheel.

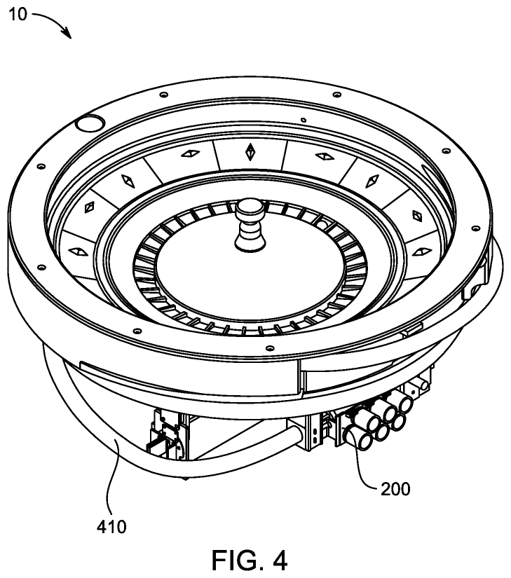

FIGS. 4-6 provide various examples of a ball launching system 200 mounted on a roulette wheel system 10. As discussed above, a launch tube 410 may connect the ball launching system to the wheel to initiate a roulette gaming event. An inlet tube 510 can deliver a ball into the ball launching system via inlet 280. The inlet tube may be connected to inlet 280 on one end, and any of a ball loading magazine, roulette ball storage container, or an exit point from the wheel, among others. In some examples, roulette ball may be received at the ball launching system from one of any of a variety of locations. Although only one inlet tube 510 and one launch tube 410 are shown, additional tubes may be applied. This may allow roulette balls to be received from and delivered to any of a plurality of locations.

As seen in FIG. 5 and discussed herein, the roulette wheel system 200 may be mounted at an angle to allow a roulette ball to roll towards and rest at the start position. The tilt may be any angle, depending on mounting and design considerations, so long as the inlet position is at a greater height than the starting position.

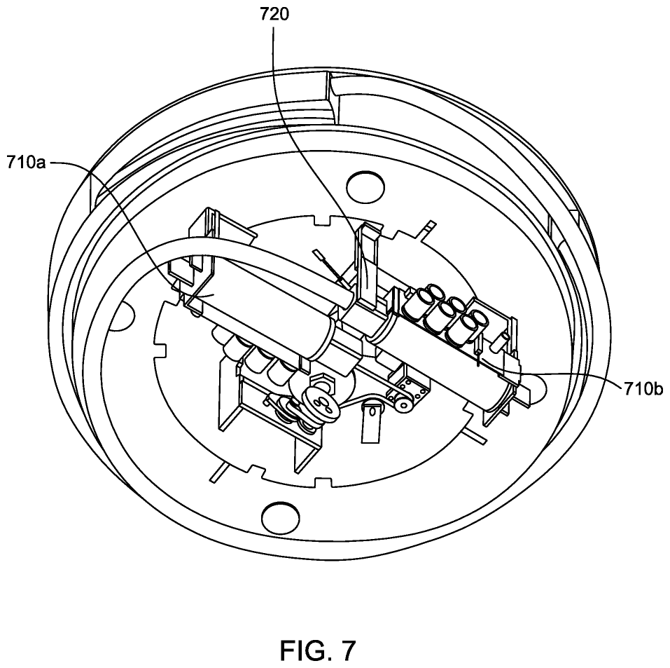

FIG. 7 provides a bottom perspective view of an example roulette gaming device with multiple ball launching systems 710a. 710b. A mount 720 may secure one or more ball launching systems to an underside of a gaming device, such as a roulette wheel. The ball launching systems 710a, 710b may each receive roulette balls from one or more locations, such as a same location or a different location. Each system may be connected to an inlet tube, which may receive balls from a ball magazine. Each system 710a, 710b may haves separate launch tubes, which can launch a roulette ball into the roulette wheel at a same or different location. As shown in FIG. 7 only one launch tube is shown so that all of the other components of the roulette gaming device are visible.

In an embodiment, a joint launch tube may connect a ball path of the roulette ball after exiting from each respective system 710a, 710b. The dual launch system configuration may enable additional roulette balls to be launched at a given time, and at a greater rate than a single launch system. The ability to launch roulette balls from multiple launch systems may provide variety and excitement to roulette gaming events. For example, players may launch balls at a faster rate, thus increasing a speed of gameplay. This increased launch ability enables a greater variety of roulette games, such as games with multiple roulette balls, rapid launches, bonus launches, and the like. Although FIG. 7 illustrates an example with two ball launch systems, more may be added, depending on various gaming needs and considerations.

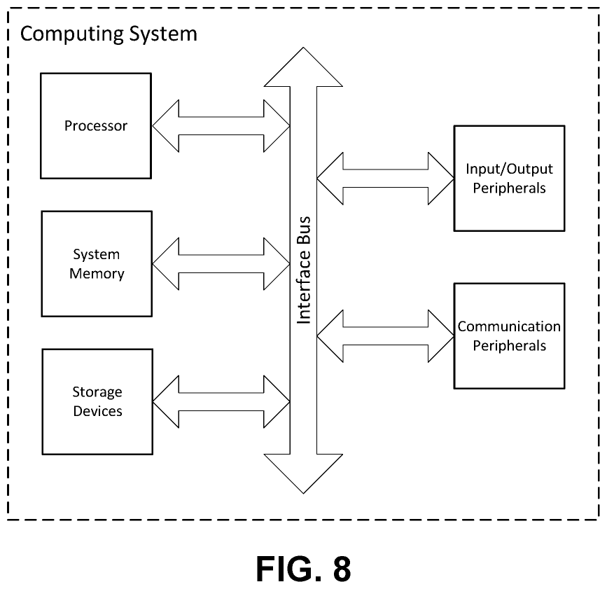

Some of the techniques described above can be implemented on a computing device associated with a gaming device (e.g., a roulette mechanism), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, some of the techniques may be distributed between the computing device(s) and the controller(s). FIG. 8 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the shooter selection and console mirroring, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

In an embodiment, a ball launch system may include an electromagnetic coil comprising a plurality of windings around a ball path, a magnetic piston configured to travel along the ball path, and a control system configured to receive a launch signal from a roulette gaming device and sequentially activate a first winding and a second winding of the electromagnetic coil to accelerate the magnetic piston from a start position, wherein the accelerated magnetic piston launches a roulette ball positioned within the ball path through an exit point of the ball path at a timing and a speed associated with the launch signal.

In another embodiment, the control system sequentially activates the first winding and the second winding by: applying a first current to the first winding to drive the magnetic piston from a start position to a first position, and applying a second current to the second winding to adjust a speed of the magnetic piston.

In another embodiment, the first current and the second current have opposite polarities.

In another embodiment, a sensor may be configured to determine a position of the magnetic piston within the ball path, and the control system may dynamically adjust a timing for activating the first winding and second winding based on the position.

In another embodiment, the ball launch system further includes a player-activated launch controller configured to generate the launch signal.

In another embodiment, the electromagnetic coil and the magnetic piston are angled to enable the roulette ball to roll to the start position when received at the ball path.

In another embodiment, the electromagnetic coil comprises six windings.

In another embodiment, the ball launch system further includes a set of rods configured to guide the magnetic piston along the ball path.

In another embodiment, the ball launch system further includes a sensor to determine a position of the magnetic piston, and wherein the control system activates the second winding at a time based on the position.

In another embodiment, a first end of the magnetic piston comprises synthetic material serving as sliding bearing.

In an embodiment, a method for launching a roulette ball, comprises: receiving a roulette ball at a start position, applying a first current to a first winding of an electromagnetic coil to drive a magnetic piston at the start position along a ball path defined by the electromagnetic coil, applying a second current to a second winding of the electromagnetic coil to adjust a speed of the magnetic piston, driving, by the magnetic piston, a roulette ball through an exit point of the ball path, wherein the roulette ball reaches the exit point at a timing and a speed associated with a launch command, and returning the magnetic piston to the start position.

In another embodiment, applying the second current occurs at a timing when the magnetic piston reaches the second winding.

In another embodiment, the second current is configured to slow the speed of the magnetic piston, and wherein first current and second current have opposite polarities.

In another embodiment, applying a third current to the first winding or the second winding to return the magnetic piston to the start position.

In another embodiment, the second current increases the speed of the magnetic piston.

In another embodiment, further comprising sensing a position of the magnetic piston and dynamically adjusting a timing for applying each of the first current and the second current, based on the magnetic piston position.

In an embodiment, a roulette gaming method, comprises: receiving a launch command from a player-activated launch controller, the launch command indicative of a speed and a timing for launching a roulette ball from a start position into a rotating roulette wheel, generating a ball launch sequence based on the launch command, the ball launch sequence comprising: applying a first current to a first winding of an electromagnetic coil to drive a magnetic piston from a start position along a ball path defined by the electromagnetic coil, and applying a second current to a second winding of the electromagnetic coil to adjust a speed of the magnetic piston, and launching the roulette ball according to the ball launch sequence.

In another embodiment, further comprising: receiving a first wheel command from the player-activated launch controller, and adjusting a speed of rotation of the roulette wheel based on the first wheel command, wherein adjusting the speed occurs before or after launching the roulette ball.

In another embodiment, further comprising: receiving a second wheel command from the player-activated launch controller, and adjusting a speed of rotation of the roulette wheel based on the second wheel command, wherein adjusting the speed occurs after bets close.

In another embodiment, further comprising: receiving a second launch command from the player-activated launch controller, and launching a second roulette ball into the rotating roulette wheel.

As previously noted, the various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed:

1. A ball launch system, comprising:
an electromagnetic coil comprising a plurality of windings around a ball path;
a magnetic piston configured to travel along the ball path; and
a control system configured to receive a launch signal from a roulette gaming device and sequentially activate a first winding and a second winding of the electromagnetic coil to accelerate the magnetic piston from a start position, wherein the accelerated magnetic piston launches a roulette ball positioned within the ball path through an exit point of the ball path at a timing and a speed associated with the launch signal.

2. The ball launch system of claim 1, wherein the control system sequentially activates the first winding and the second winding by:
applying a first current to the first winding to drive the magnetic piston from a start position to a first position, and
applying a second current to the second winding to adjust a speed of the magnetic piston.

3. The ball launch system of claim 2, wherein the first current and the second current have opposite polarities.

4. The ball launch system of claim 1, further comprising a sensor configured to determine a position of the magnetic piston within the ball path, and wherein the control system dynamically adjusts a timing for activating the first winding and second winding based on the position.

5. The ball launch system of claim 1, further comprising a player-activated launch controller configured to generate the launch signal.

6. The ball launch system of claim 1, wherein the electromagnetic coil and the magnetic piston are angled to enable the roulette ball to roll to the start position when received at the ball path.

7. The ball launch system of claim 1, wherein the electromagnetic coil comprises six windings.

8. The ball launch system of claim 1, further comprising a set of rods configured to guide the magnetic piston along the ball path.

9. The ball launch system of claim 1, further comprising a sensor to determine a position of the magnetic piston, and wherein the control system activates the second winding at a time based on the position.

10. The ball launch system of claim 1, wherein a first end of the magnetic piston comprises synthetic material serving as sliding bearing.

11. A method for launching a roulette ball, comprising:
receiving a roulette ball at a start position;
applying a first current to a first winding of an electromagnetic coil to drive a magnetic piston at the start position along a ball path defined by the electromagnetic coil;
applying a second current to a second winding of the electromagnetic coil to adjust a speed of the magnetic piston;
driving, by the magnetic piston, a roulette ball through an exit point of the ball path, wherein the roulette ball reaches the exit point at a timing and a speed associated with a launch command; and
returning the magnetic piston to the start position.

12. The method of claim 11, wherein applying the second current occurs at a timing when the magnetic piston reaches the second winding.

13. The method of claim 11, wherein the second current is configured to slow the speed of the magnetic piston, and wherein first current and second current have opposite polarities.

14. The method of claim 11, further comprising:
applying a third current to the first winding or the second winding to return the magnetic piston to the start position.

15. The method of claim 11, wherein the second current increases the speed of the magnetic piston.

16. The method of claim 11, further comprising sensing a position of the magnetic piston and dynamically adjusting a timing for applying each of the first current and the second current, based on the magnetic piston position.

17. A roulette gaming method, comprising:
receiving a launch command from a player-activated launch controller, the launch command indicative of a speed and a timing for launching a roulette ball from a start position into a rotating roulette wheel;
generating a ball launch sequence based on the launch command, the ball launch sequence comprising:
applying a first current to a first winding of an electromagnetic coil to drive a magnetic piston from a start position along a ball path defined by the electromagnetic coil; and
applying a second current to a second winding of the electromagnetic coil to adjust a speed of the magnetic piston; and
launching the roulette ball according to the ball launch sequence.

18. The roulette gaming method of claim 17, further comprising:
receiving a first wheel command from the player-activated launch controller; and
adjusting a speed of rotation of the roulette wheel based on the first wheel command, wherein adjusting the speed occurs before or after launching the roulette ball.

19. The roulette gaming method of claim 18, further comprising:
receiving a second wheel command from the player-activated launch controller; and
adjusting a speed of rotation of the roulette wheel based on the second wheel command, wherein adjusting the speed occurs after bets close.

20. The roulette gaming method of claim 17, further comprising:
receiving a second launch command from the player-activated launch controller; and
launching a second roulette ball into the rotating roulette wheel.
